(19) United States
(12) Patent Application Publication
(10) Pub. No.: US 2011/0130198 A1
(43) Pub. Date: Jun. 2, 2011

(54) GAMING SYSTEM

(76) Inventor: Lucien M. VAN LINDEN, Maasland (NL)

(21) Appl. No.: 12/627,422

(22) Filed: Nov. 30, 2009

(51) Int. Cl. G06F 17/00

(52) U.S. Cl. 463/27

(57) ABSTRACT

A gaming system for playing one or more games, comprising registration means for registering data representative of non-winning outcomes of playing said one or more games, and bonus delivery means for delivering a bonus upon the registered data matching certain criteria, e.g. a determination that the registered non-winning outcomes match a certain number. Many options for a suitable bonus exist, such as an amount of money, a prize, a credit for further playing, an in-game enhancement and a progressive jackpot. In an embodiment the system comprises a plurality of interconnected gaming machines, the registration means being configured to register the data representative of non-winning outcomes from each of the plurality of interconnected gaming machines. Also a bonus provision device for use with such a gaming system, comprising the already-mentioned registration means as well as signaling means for providing a bonus delivery signal to external bonus delivery means.

### FIELD OF THE INVENTION

The invention relates to a gaming system for playing one or more games.

The invention further relates to a bonus provision device for use with such a system.

The invention further relates to a computer program.

### BACKGROUND OF THE INVENTION

Gaming systems, ranging from simple hand-held devices such as Sony's PlayStation Portable or personal computers to groups of interconnected slot machines, in large casinos, are provided with a large variety of options to encourage or reward players. One option is to provide a bonus to players under certain circumstances, for example in computer games a bonus when the player achieves a certain number of points or manages to complete certain levels or challenges. In casinos, a bonus may be provided if a player manages to line up the highest paying combination of symbols on a slot machine.

The bonus may also be tied to random events. The so-called progressive jackpot on slot machines is an example: a fixed percentage of every wager is added to the current amount of the progressive jackpot. This jackpot can be won whenever the symbols required to win the jackpot (the bonus) are lined up at the correct win-line with the correct number of coins wagered. The slot machine that displays this combination wins the progressive jackpot. Even more random is the mystery jackpot, where the jackpot (the bonus) is paid out when the amount in the jackpot reaches a randomly chosen level.

When bonus delivery is tied to a (pseudo-)random event, the gaming system is subject to strict regulation in many jurisdictions. The random number generator that is at the heart of such bonus delivery must then meet certain standards before it may enter the market. For certain jurisdictions, every piece of equipment that has an embedded random generator is qualified as a gambling machine and cannot be bought or sold without a license of that particular jurisdiction. In other jurisdictions such gambling machines may be illegal outright.

Tying bonus delivery to a non-random event such as a certain number of wins of points achieved in a game avoids these regulations. However, this limits the possibilities of providing bonuses, in particular in slot machines and the like. Moreover, many of these events are easily remembered or kept track of by players, which is not in the interest of the operator of the machines as it provides an unfair way to obtain the bonus. There thus is a need to provide a gaming system with bonus delivery means that do not rely on random number generators yet provide an attractive challenge for players.

### SUMMARY OF THE INVENTION

The invention advantageously provides a gaming system for playing one or more games, comprising registration means for registering data representative of non-winning outcomes of playing said one or more games, and bonus delivery means for delivering a bonus upon the registered data matching certain criteria. This system avoids the need for a random number generator to determine whether the bonus is to be provided to a player. The non-winning outcomes are a given which can be tracked and registered, and the criteria for determining if the bonus is to be delivered are entirely deterministic.

In one embodiment, the criterion is whether the registered non-winning outcomes match a certain number, effectively providing bonus delivery when a certain number of games or rounds have been lost. Additional enhancements or modifications are possible, for example by only registering non-winning outcomes that meet certain predefined conditions. While many options for a suitable bonus exist, some preferred choices are: an amount of money, a prize, a credit for further playing, an in-game enhancement and a progressive jackpot.

In an embodiment the system comprises a plurality of interconnected gaming machines, the registration means being configured to register the data representative of non-winning outcomes from each of the plurality of interconnected gaming machines. In this way multiple gaming machines contribute to delivery of the same bonus, making game play more exciting.

The invention further advantageously provides a bonus provision device for use with a gaming system for playing one or more games, comprising registration means for registering data representative of non-winning outcomes of playing said one or more games, and signaling means for providing a bonus delivery signal to bonus delivery means external to the bonus provision device that the registered data matches certain criteria so as to cause the bonus delivery means to deliver a bonus. This device can be coupled to gaming systems to easily provide the functionality of the present invention.

The invention further advantageously provides a computer program product comprising machine-executable instructions to enable a programmable device to implement the invention. The program product comprises instructions for registering data representative of non-winning outcomes of playing said one or more games, and for providing a bonus delivery signal to bonus delivery means that the registered data match certain criteria so as to cause the bonus delivery means to deliver a bonus. The product is preferably recorded on a storage medium such as a semiconductor memory device, magnetic disk, magneto-optical disks and CD-ROM disks.

### BRIEF DESCRIPTION OF THE FIGURES

The invention will now be elaborated upon with reference to the figures, in which

FIG. 1 schematically shows a gaming system for playing one or more games;

FIG. 2 schematically shows an alternative embodiment of the gaming system;

FIG. 3 schematically shows a bonus provision device; and

FIG. 4 shows a flowchart of processing steps of a computer-implemented method.

### DETAILED DESCRIPTION

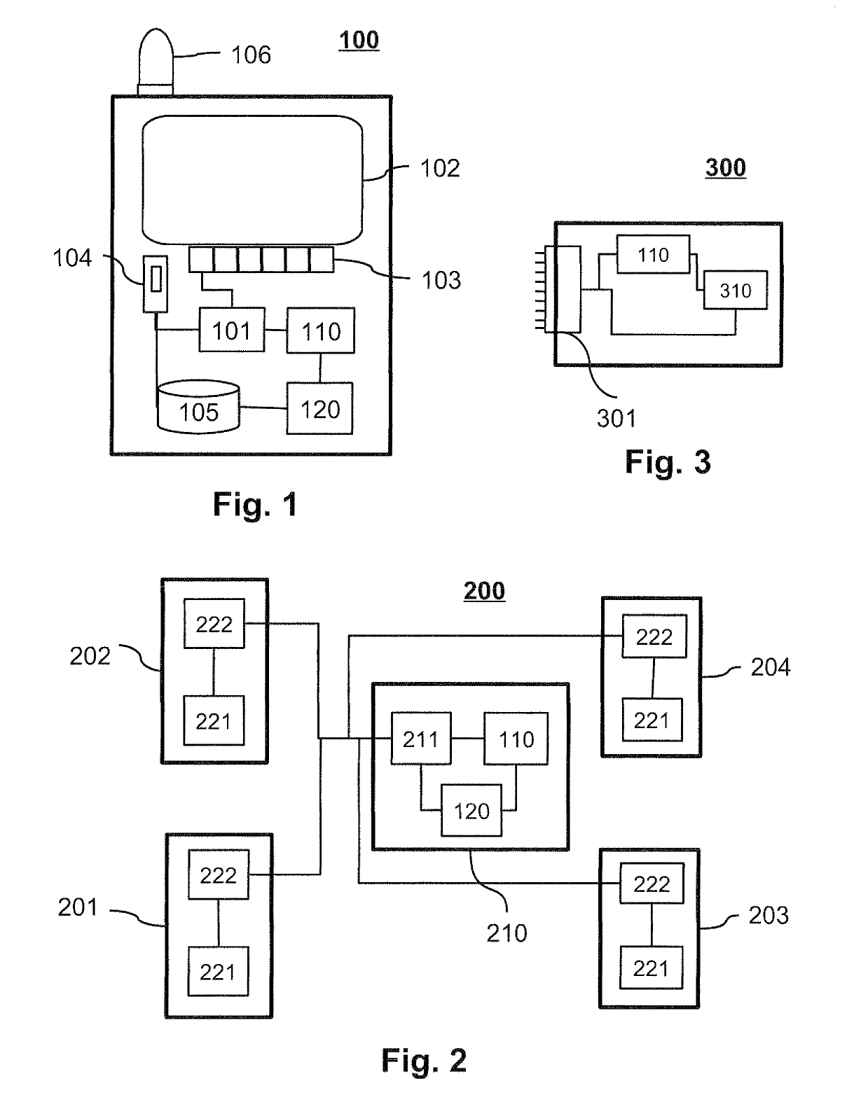

FIG. 1 schematically shows a gaming system for playing one or more games in accordance with the invention. In this embodiment the gaming system 100 is a single gaming machine. An extremely large variety of such gaming machines exist. To name a few: game computers such as the Sony PlayStation, Microsoft XBox or Nintendo Wii; their portable or hand-held equivalents the Nintendo Gameboy, N-Gage, and DS or Sony PlayStation Portable; personal computers loaded with game software; smartphones such as the Apple iPhone or HTC Magic; casino machines such as poker machines, slot machines or keno machines.

The gaming system 100 may be configured to allowing the playing of a single game, as is often the case with casino machines, or to allow the playing of multiple games. For the sake of simplicity, in the system 100 of FIG. 1, a gaming module 101 is shown that allows a user to play a single game, for example video poker. A display 102 and row of buttons 103 is provided for output and input, allowing the player to interact with the game. Optionally, the gaming system 100 further comprises a payment module 104 through which the user must provide payment in order to be allowed to play the game. This payment module 104 can be implemented e.g. as a coin or paper money slot or a credit card reader. For games on game computers such as the Sony PlayStation or on a personal computer payment is often effected on a subscription or pay-as-you-go basis, e.g. by purchasing credits in advance and using a certain number of credits for every game. In FIG. 1, a coin storage 105 is provided for storing coins provided through payment module 104. The gaming system 100 may be configured to deliver an amount of money, e.g. from coin storage 105, a prize or in-game enhancements if the player achieves a winning outcome, for example if the player wins a round or match in the game or otherwise achieves a result that is deemed winning.

The gaming system 100 further comprises a registration module 110 for registering data representative of non-winning outcomes of playing said one or more games. If the registered data matching certain criteria, a signal is provided to bonus delivery module 120 which delivers a bonus to the player. Such criteria may for instance comprise a determination whether the registered non-winning outcomes match a certain number. The delivery of a bonus is by itself a well-known concept. Common examples of bonuses are amounts of money, prize such as cars, boats or electronic equipment, credits for further playing and in-game enhancements such as more powerful weapons, extra lives or access to special levels or challenges. In the embodiment of FIG. 1, the bonus is a payout of money accumulated in the coin storage 105.

Instead of delivering the bonus directly, the bonus delivery module 120 may be configured to delivery the bonus by signaling an external apparatus or a person, e.g. a casino floor manager, that the bonus has been earned by a particular player. This avoids the need for the gaming system 100 to also comprise the means for the physical delivery of the bonus, which may be unwieldy or costly to guard when the bonus is large. Some gaming machines may be configured to deliver small bonuses directly and to signal the external apparatus or person only for large bonuses.

In ease the gaming system is embodied as a slot machine, poker machine or other casino-style gaming system, a preferable choice of bonus is a progressive jackpot. This type of jackpot starts as an amount of money set at an initial value and increments with every round or game played. A fixed percentage of every wager is added to the current amount of the progressive jackpot. This current amount may be indicated on the gaming system 100 or a separate display to encourage players. Upon meeting the winning condition, the winning player is paid out the entire jackpot and the jackpot is reset to the initial value. Such a jackpot is highly attractive to players, in particular when multiple gaming machines operate in parallel to increase the jackpot.

In a specific embodiment the gaming system 100 comprises an attention mechanism to indicate to the player that he will receive the bonus. Shown is a light 106 that will flash in this event, but many other mechanisms could also be thought of. For example, the gaming system 100 may pause the game, lock the machine, display a textual and/or graphical message, play a video or a combination of these events. Such mechanisms are by themselves well-known.

An outcome may represent the outcome of the game as a whole or the outcome of individual rounds or events in the game. For example, in a game of Roulette each game has only one outcome: the winning number and its properties of being red, black, odd, even and so on. In computer games, the player may play distinct rounds or levels, with an identifiable outcome for each one. In a boxing or other fighting game the result of each round of boxing may be regarded as the outcome, or the result of complete fights against particular opponents or even the results of a complete tournament in which the player faces multiple opponents may be so regarded.

What exactly constitutes a “non-winning outcome” and what criteria to apply to determine if the bonus is to be delivered depends on the game. Given a particular game the skilled person will be able to easily formulate what constitutes a non-winning outcome for that game and design the gaming module 101 to provide an appropriate signal to the registration module 110 for registering the data representative of that fact. For example, in a poker game only one player can win the pot, hence all other players have non-winning outcomes. In other games, there may be multiple kinds of outcome, some or all of which may qualify as non-winning.

For example in the game of Blackjack, players that go over twenty-one or who are beaten by the house may all be regarded as having non-winning outcomes. Alternatively, only being beaten by the house may be regarded as a non-winning outcome. In Roulette, a player may have placed multiple bets simultaneously. In this case, each bet that does not result in a payout may be regarded as a non-winning outcome. Alternatively, only the fact that none of the bets result in a payout might be regarded as a non-winning outcome. In slot machines and the like, a non-winning outcome may be regarded as any outcome where the player is not awarded points or no payout of money occurs.

It is possible that a game may have an outcome that qualifies as neither winning nor non-winning, for example a draw or stalemate. However, in most cases an outcome will be qualified as either winning or non-winning.

The registration of data representative of non-winning outcomes may be as simple as increasing a counter that counts the number of non-winning outcomes. This allows for a criterion for bonus delivery in the form of reaching a predetermined number. The predetermined number can be programmed into the registration module 110 by an operator. The data may also comprise other information, such as the date and/or time that particular non-winning outcomes occurred. This allows e.g. for excluding non-winning outcomes that occurred too long ago.

In embodiments where multiple types of non-winning outcomes are possible, the type may be registered as well. In such embodiments the type may influence the count, for example by applying a multiplier to outcomes of a particular types. To take the Blackjack example again, the number of non-winning outcomes resulting from going over 21 may be weighed more heavily than the number of non-winning outcomes resulting from being beaten by the bank. This could be implemented by multiplying the first number with a certain factor before adding up the second number. Again, the criterion could be whether the total matches a predefined number. Alternatively in this case, the outcomes are counted separately by type and each count must match or exceed separate predefined numbers. E.g. in the Blackjack example at least 75 outcomes of being beaten by the bank and at least 108 outcomes of going over 21 must occur before bonus delivery takes place.

In embodiments where a game may be played on different levels of difficulty, this level may be part of the determination. For example, a multiplier can be applied that relates to the level of difficulty, which means that a non-winning outcome at a difficult level weighs more heavily than a non-winning outcome at an easy level of play.

In a further embodiment, the registration module 110 only registers non-winning outcomes that meet certain predefined conditions. Such conditions are for example that the non-winning outcome occurred too early in the game, that too many consecutive non-winning outcomes occurred, that the non-winning outcome is at too low or high a level of difficulty or that a bet, wager or other input from the player is below a certain limit. Such outcomes could be disregarded when determining if the bonus is to be delivered. Certain games may be excluded from registration, for example because they are too easy.

If individual players can be identified or tracked somehow, this information can also be used as part of these conditions. For instance a condition could be that at least ten different players must have achieved an outcome before any bonus delivery may occur or that a player does or does not occur in a list of top players.

In a yet further embodiment the registration module 110 is configured to additionally register data representative of winning outcomes. This allows for more complex criteria to determine if the bonus is to be delivered, namely by requiring a specific relationship between the numbers of winning and non-winning outcomes. For example, one may require that the number of non-winning outcomes is at least a certain limit and at the same time no less than ten times the number of winning outcomes.

In another embodiment the registration module 110 is not activated at all times when the gaming system 100 is being used. In this embodiment some particular event is necessary to activate the registration module, for example the player must achieve some specific result or make an extra payment. As a refinement of this embodiment the registration module 110 may be deactivated after another particular event occurs, for example a certain time has lapsed since its activation or the bonus delivery has occurred.

FIG. 2 schematically shows an alternative embodiment of the gaming system according to the invention. In this alternative embodiment the gaming system 200 comprises a plurality of interconnected gaming machines 201, 202, 203, 204. Each machine 201, 202, 203, 204 comprises a separate gaming module 221 which is equivalent to gaming module 101, as well as other functionality as already discussed with reference to the single-machine embodiment of FIG. 1. For the sake of brevity the other functionality is not shown in FIG. 2. In addition to the already-discussed functionality, the gaining module 221 may enable the playing of multiplayer games, e.g. poker, Blackjack, racing or fighting games. Each machine 201, 202, 203, 204 further comprises a communication module 222 which is configured to communicate with the other machines 201, 202, 203, 204.

Further a central computer 210 is provided that comprises the registration means 110. The communication module 222 in each individual machine 201, 202, 203, 204 is configured to deliver the necessary data to a communication module 211 in central computer 210. The registration module 110 then adds up or otherwise combines the received data from the individual machines in order to determine if the criteria are met.

In an alternative embodiment each machine 201, 202, 203, 204 may be provided with its own registration module 110 that registers data representative of non-winning outcomes of playing on that machine. The communication module 222 provides this registered data to the central computer 210. The central computer 210 again adds up or otherwise combines the received data from the individual machines in order to determine if the criteria are met.

In either embodiment the bonus delivery module 120 may be placed in the central computer 210, as shown in FIG. 2, or in the individual machines 201, 202, 203, 204. By placing the module 120 in the central computer 210 the bonus can be delivered centrally, allowing the delivery of greater monetary awards or prizes or the attraction of more attention to the fact that a bonus is about to be delivered. The central computer 210 may comprise its own attention mechanism 106 and/or signal to the individual machine 201, 202, 203, 204 to whose player the bonus is to be delivered that its attention mechanism 106 is to be activated.

In yet another alternative embodiment each of the individual machines 201, 202, 203, 204 is provided with its own registration module 110 and communication module 222. The registration modules 110 register data representative of non-winning outcomes of playing on the respective machines 201, 202, 203, 204, and the communication modules 222 provide this registered data to all other individual machines 201, 202, 203, 204, where the received registered data is added up or otherwise combined in order to determine if the criteria are met. This obviates the need for central computer 210.

This embodiment allows the delivery of bonuses based on the outcomes of games on the multiple machines 201, 202, 203, 204. Such gaming systems are by themselves well-known. For instance, in U.S. Pat. No. 5,564,700 and U.S. Pat. No. 5,611,730 in a group of interconnected gaming machines a bonus in the fowl of a progressive jackpot is provided that pays a proportion of the jackpot to eligible players at each linked machine. When a progressive jackpot-winning outcome occurs at one of the linked machines, the winning machine signals the controller which then announces the win. U.S. Pat. No. 6,015,347 provides a progressive jackpot feature which includes a dealer operated keypad unit located at each casino table for entering information which is used to recalculate the progressive jackpots. In U.S. Pat. No. 5,941,773 a bonus in the form of a random jackpot is provided. A central server determines if a particular individual machine is eligible for bonus delivery. Although none of these systems disclose registering data representative of non-winning outcomes of playing games or delivering a bonus upon the registered data matching certain criteria, they may be adapted to incorporate these features.

FIG. 3 schematically shows a bonus provision device in accordance with the present invention for use with a gaming system. The bonus provision device 300 is designed as a separate device that can be coupled to gaming systems to easily provide the functionality of the present invention. The device 300 comprises the registration module 110 for registering data representative of non-winning outcomes of playing one or more games on the gaming system to which is it coupled. The device further comprises signaling module 310 which providing a bonus delivery signal to bonus delivery module 120 external to the bonus provision device that the registered data matches certain criteria so as to cause the bonus delivery module 120 to deliver a bonus.

To couple the device 300 to a gaming system, I/O module 301 is provided which enables the device 300 to receive data from and send data to the gaming system 300. Most gaming systems have standardized on certain connectors or I/O ports, for example serial ports, USB or Firewire.

In an alternative embodiment the signaling module 310 employs a different output (not shown) to provide its bonus delivery signal to bonus delivery module 120. This is advantageous if the gaming system to which the device 300 is coupled does not support the delivery of bonuses, or if it is not possible to employ I/O module 301 to provide an interface with bonus delivery module 120. This embodiment can also be used when bonus delivery is centralized, for example when the bonus is a prize such as a car or boat. A separate bonus delivery system (not shown) can be set up to receive the signals from the signaling module 310 and deliver the bonus from the centralized location.

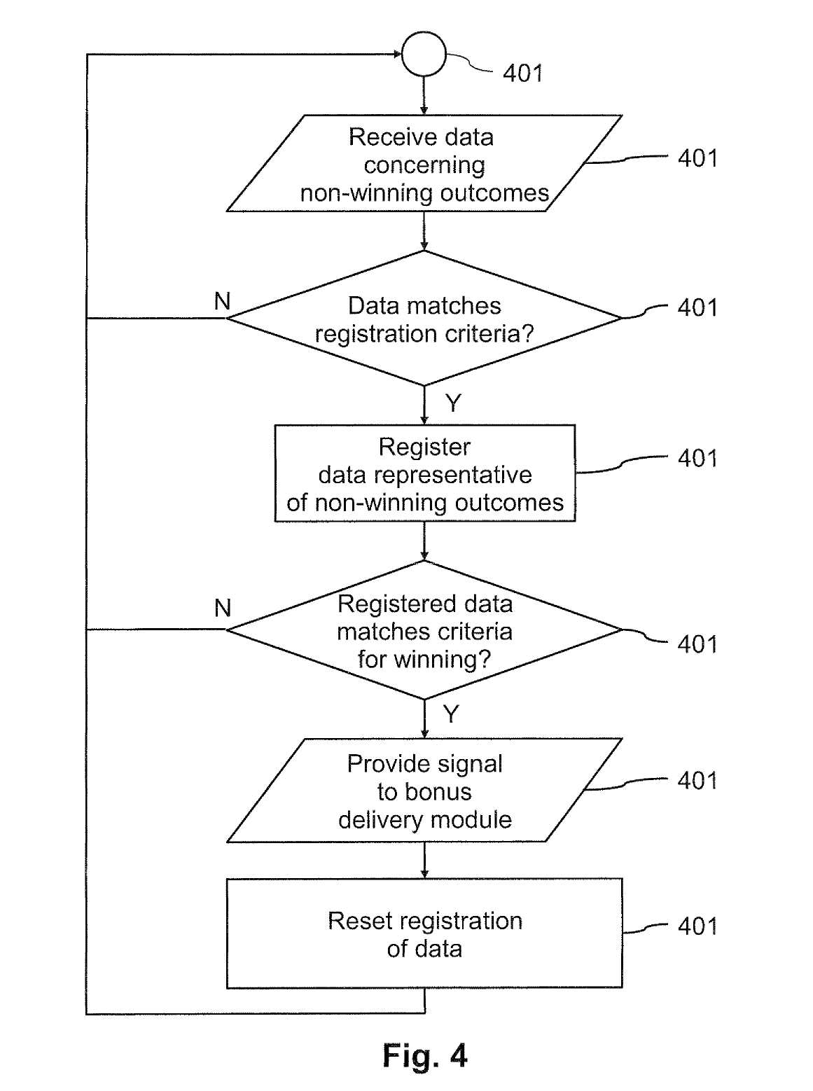

FIG. 4 shows a flowchart of processing steps of a computer-implemented method in accordance with the present invention. Using a computer program this method can be easily implemented on a gaming system to provide the functionality of the present invention. Such a computer program product, i.e. a collection of computer program instructions stored on a computer readable storage device for execution by a computer. These instructions may be in any interpretable or executable code mechanism, including but not limited to scripts, interpretable programs, dynamic link libraries (DLLs) or Java classes. The instructions can be provided as complete executable programs, as modifications to existing programs or extensions (“plugins”) for existing programs. Upon program startup 401, the computer program in step 402 waits until it receives data concerning non-winning outcomes of playing one or more games. This data may be as simple as a one-bit signal indicating a non-winning outcome has occurred. As discussed with reference to FIG. 1, the data may comprise various extra information items, such as the type of game or type of non-winning outcome.

In optional step 403, the received data is tested to see if it matches certain predefined conditions, for example that the non-winning outcome occurred too early in the game, that too many consecutive non-winning outcomes occurred or that a bet, wager or other input from the player is below a certain limit. If the data does not match the conditions, the program returns to step 402. Otherwise the program continues with step 404.

In step 404, data representative of the non-winning outcomes of playing said one or more games is registered. As already discussed with reference to FIG. 1, this data can be registered in many ways. In one embodiment, the representative data is simply a counter that is incremented by one every time data representative of a non-winning outcome is received in step 402.

Next, in step 405 the program determines if the representative data matches the criteria for bonus delivery. In the above-mentioned counter embodiment, the criterion is whether the counter has reached a predefined number. If not, the program returns to step 402. If the criteria are matched, the program continues to step 406, where a signal is provided to the bonus delivery module 120 so as to cause the bonus delivery means 120 to deliver a bonus. After signaling that a bonus is to be delivered, the program clears or resets the representative data in step 407, for example by resetting the above-mentioned counter to zero.

The above provides a description of several useful embodiments that serve to illustrate and describe the invention. For the sake of brevity, well-known methods, procedures, components, and circuits have not been described in detail. The description is not intended to be an exhaustive description of all possible ways in which the invention can be implemented or used. The skilled person will be able to think of many modifications and variations that still rely on the essential features of the invention as presented in the claims. Moreover, parts of the processing of the present invention may be distributed over multiple computers or processors for better performance, reliability, and/or cost.

The computer program product may be provided to the gaming system recorded on a machine-readable storage device. Machine-readable storage devices suitable for storing computer program instructions include all forms of non-volatile memory, including by way of example semiconductor memory devices, such as EPROM, EEPROM, and flash memory devices, magnetic disks such as the internal and external hard disk drives and removable disks, magneto-optical disks and CD-ROM disks. The computer program product can be distributed on such a storage device, or may be offered for download through HTTP, FTP or similar mechanism using a server connected to a network such as the Internet. Transmission of the computer program product by e-mail is of course also possible. To this end one may connect a server system comprising the storage medium discussed above to a network, and arrange this server for allowing the instructions to be downloaded to client systems connected directly or indirectly to the network.

When constructing or interpreting the claims, any mention of reference signs shall not be regarded as a limitation of the claimed feature to the referenced feature or embodiment. The use of the word “comprising” in the claims does not exclude the presence of other features than claimed in a system, product or method implementing the invention. Any reference to a claim feature in the singular shall not exclude the presence of a plurality of this feature. The word “means” in a claim can refer to a single means or to plural means for providing the indicated function.

1. A gaming system for playing one or more games, comprising registration means for registering data representative of non-winning outcomes of playing said one or more games, and bonus delivery means for delivering a bonus upon the registered data matching certain criteria.

2. The gaming system of claim 1, in which the registration means are configured to only register non-winning outcomes that meet certain predefined conditions.

3. The gaming system of claim 1, in which the registration means are configured to additionally register data representative of winning outcomes, and the certain criteria comprise a relationship between the winning and non-winning outcomes.

4. The gaming system of claim 1, comprising a plurality of interconnected gaming machines, the registration means being configured to register the data representative of non-winning outcomes from each of the plurality of interconnected gaming machines.

5. The gaming system of claim 4, in which the registration means are provided in a central computer in a network that connects the gaming machines of said plurality.

6. The gaming system of claim 1, where the bonus is at least one of: an amount of money, a prize, a credit for further playing, an in-game enhancement and a progressive jackpot.

7. A bonus provision device for use with a gaming system for playing one or more games, comprising registration means for registering data representative of non-winning outcomes of playing said one or more games, and signaling means for providing a bonus delivery signal to bonus delivery means external to the bonus provision device that the registered data matches certain criteria so as to cause the bonus delivery means to deliver a bonus.

8. A computer program product for use with a gaming system for playing one or more games, comprising instructions for registering data representative of non-winning outcomes of playing said one or more games, and for providing a bonus delivery signal to bonus delivery means that the registered data matches certain criteria so as to cause the bonus delivery means to deliver a bonus.

9. A storage medium having recorded the computer program product of claim 8.
